(19) United States
(12) Patent Application Publication
(10) Pub. No.: US 2025/0253419 A1
(43) Pub. Date: Aug. 7, 2025

(54) STORAGE BATTERY SYSTEM

(71) Applicant: TOYOTA JIDOSHA KABUSHIKI KAISHA, Toyota-shi (JP)

(72) Inventors: Hiroshi HOSOKAWA, Nagoya-shi (JP); Kenji TAKAHASHI, Toyota-shi (JP); Toshio UCHIYAMA, Toyota-shi (JP)

(73) Assignee: TOYOTA JIDOSHA KABUSHIKI KAISHA, Toyota-shi (JP)

(21) Appl. No.: 18/956,480

(22) Filed: Nov. 22, 2024

(30) Foreign Application Priority Data
Feb. 7, 2024 (JP) 2024-017458

(51) Int. Cl. H01M 10/48; B60R 16/033; H01M 10/42; H01M 10/613; H01M 10/625; H01M 10/6563; H01M 50/204; H01M 50/249; H01M 50/258; H02J 7/00

(52) U.S. Cl. CPC H01M 10/482; B60R 16/033; H01M 10/425; H01M 10/613; H01M 10/625; H01M 10/6563; H01M 50/204; H01M 50/249; H01M 50/258; H02J 7/0013; H02J 7/0047; H01M 2010/4271; H01M 2220/20

(57) ABSTRACT

A control device of a storage battery system can determine a deterioration level of each of first storage battery modules and second storage battery modules. In addition, the control device can give a notification of at least one of exchange between a predetermined first storage battery module and a predetermined second storage battery module and change of storage positions of the predetermined first storage battery module and the predetermined second storage battery module, in accordance with the deterioration level of each of the first storage battery modules and the second storage battery modules.

### CROSS-REFERENCE TO RELATED APPLICATION

This application claims priority to Japanese Patent Application No. 2024-017458 filed on Feb. 7, 2024, incorporated herein by reference in its entirety.

### BACKGROUND

### 1. Technical Field

The disclosure relates to a storage battery system.

### 2. Description of Related Art

Japanese Unexamined Patent Application Publication No. 2019-164915 discloses the disclosure relating to a storage battery device. The storage battery device includes a plurality of storage battery modules and a control unit that are disposed in a housing of the storage battery device. The control unit includes a connector for expansion to which a storage battery module for expansion can be connected.

### SUMMARY

Incidentally, in the related art described above, when a battery module is added, the storage battery module for expansion is disposed in the housing, and a cover of the housing is replaced along therewith. It is thus considered that work of adding a battery module becomes complicated.

Further, the battery module is deteriorated in accordance with the number of times of charging and discharging or the like, but the related-art literature described above does not refer to a countermeasure or the like against the deterioration of the battery module.

The disclosure has been made in consideration of the above-mentioned fact, and has an object to provide a storage battery system that can be reduced in an influence caused by deterioration of a battery module while work of adding a battery module is prevented from becoming complicated.

A storage battery system according to a first aspect includes: a main electricity storage device including a first housing unit, a plurality of first storage battery modules stored in the first housing unit, a cooling unit that is stored in the first housing unit and is configured to cool inside of the first housing unit, and a control unit that is stored in the first housing unit and is configured to control charging and discharging of the first storage battery modules; and an electricity storage device for expansion including a second housing unit, and a plurality of second storage battery modules stored in the second housing unit, the second storage battery modules being electrically connectable to the first storage battery modules and exchangeable with the first storage battery modules, the second storage battery modules being charged and discharged under control of the control unit, in which the control unit is configured to determine a deterioration level of each of the first storage battery modules and the second storage battery modules, and to give a notification of at least one of exchange between a predetermined one of the first storage battery modules and a predetermined one of the second storage battery modules and change of storage positions of the predetermined one of the first storage battery modules and the predetermined one of the second storage battery modules, in accordance with the deterioration level.

According to the storage battery system of the first aspect, the main electricity storage device is provided, and the main electricity storage device includes the first housing unit, and the plurality of first storage battery modules and the control unit stored in the first housing unit. In addition, the control unit can control charging and discharging of the first storage battery modules, and, in this aspect, can charge the first storage battery modules by an external power supply or supply electric power from the first storage battery modules to a load.

Further, the cooling unit that can cool the inside of the first housing unit is stored in the first housing unit, and the cooling unit can cool the first storage battery modules to reduce the deterioration of the first storage battery modules.

Incidentally, when the supply of electric power to the load is insufficient only by the main electricity storage device, a storage battery module for expansion is required to be prepared. At this time, when a configuration in which the storage battery module for expansion is disposed in the first housing unit is adopted, work of changing a part of the first housing unit is required, and it is considered that installation of the storage battery module for expansion becomes complicated.

Here, in this aspect, the electricity storage device for expansion is provided, and the electricity storage device for expansion includes the second housing unit and the plurality of second storage battery modules stored in the second housing unit. In addition, the second storage battery modules can be electrically connected to the first storage battery modules, and can be charged and discharged under control of the control unit.

Accordingly, in this aspect, when the supply of electric power to the load is insufficient only by the main electricity storage device, electric power can be supplied from the electricity storage device for expansion to the main electricity storage device. That is, in this aspect, the storage battery module can be added to the main electricity storage device without disposing a storage battery module for expansion in the first housing unit.

Incidentally, the first storage battery module and the second storage battery module are deteriorated in accordance with the number of times of charging and discharging or the like, but the degree of the deterioration varies depending on each of the first storage battery module and the second storage battery module. Further, the deterioration of the first storage battery module and the second storage battery module can be more delayed as the first storage battery module and the second storage battery module are used while being cooled, and hence using a first storage battery module or a second storage battery module having a large degree of deterioration while cooling the first storage battery module or the second storage battery module allows a life of the entire storage battery system to be ensured.

Here, in this aspect, the control unit can determine the deterioration level of each of the first storage battery modules and the second storage battery modules. In addition, the control unit can give a notification of at least one of exchange between a predetermined one of the first storage battery modules and a predetermined one of the second storage battery modules and change of storage positions of the predetermined first storage battery module and the predetermined second storage battery module, in accordance with the deterioration level of each of the first storage battery modules and the second storage battery modules.

Accordingly, the control unit can give a notification of, for example, exchange between a second storage battery module having a relatively large deterioration level stored in the second housing unit and a first storage battery module having a relatively small deterioration level stored in the first housing unit.

As a result, an operator or the like who has received the notification can exchange the second storage battery module having a relatively large deterioration level and the first storage battery module having a relatively small deterioration level. Thus, the second storage battery module is brought to a coolable state, and thus the deterioration of the second storage battery module can be reduced.

Further, the control unit can give a notification of, for example, the change of the position of the first storage battery module having a relatively large deterioration level stored in the first housing unit.

As a result, the operator or the like who has received the notification can dispose, inside of the first housing unit, a first storage battery module having a relatively large deterioration level to a position that is easily cooled by the cooling unit, and dispose a first storage battery module having a relatively small deterioration level to a position that is difficult to be cooled by the cooling unit. Thus, the deterioration levels of the first storage battery modules in the first housing unit can be averaged.

As a storage battery system according to a second aspect, in the storage battery system according to the first aspect, the first storage battery modules and the second storage battery modules are mountable on a vehicle and are configured to supply electric power to the vehicle.

According to the storage battery system of the second aspect, the first storage battery modules and the second storage battery modules can be mounted on a vehicle, and can supply electric power to the vehicle.

Accordingly, for example, at the time of replacement or the like of the first storage battery module or the second storage battery module mounted on the vehicle, when the deterioration levels of the first storage battery module and the second storage battery module are smaller than the first storage battery module stored in the first housing unit or the second storage battery module stored in the second housing unit, the first storage battery module or the second storage battery module that has been mounted on the vehicle can be reused as a part of the main electricity storage device or a part of the electricity storage device for expansion.

As a storage battery system according to a third aspect, in the storage battery system according to the first aspect or the second aspect, the main electricity storage device and the electricity storage device for expansion are installed at predetermined locations.

According to the storage battery system of the third aspect, the main electricity storage device and the electricity storage device for expansion are installed at predetermined locations, and the main electricity storage device and the electricity storage device for expansion can supply electric power to, for example, a load in a building or the like.

As a storage battery system according to a fourth aspect, in the storage battery system according to any one of the first aspect to the third aspect, the cooling unit employs an air-cooled system, and the first housing unit and the second housing unit are communicated with each other.

According to the storage battery system of the fourth aspect, the cooling unit stored in the first housing unit employs the air-cooled system, and thus the first storage battery modules in the first housing unit can be cooled by cold air generated by the cooling unit so that the deterioration of the first storage battery modules can be reduced.

Further, in this aspect, the first housing unit and the second housing unit are communicated with each other. Thus, the second storage battery modules in the second housing unit can be cooled by the cold air generated by the cooling unit so that the deterioration of the second storage battery modules can be reduced.

As described above, the storage battery system according to the disclosure has an excellent effect that the influence caused by the deterioration of the battery module can be reduced while the work of adding the battery module is prevented from becoming complicated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a block diagram schematically illustrating a configuration and operation of a storage battery system according to this embodiment, and illustrates a first state;

FIG. 1B is a block diagram schematically illustrating a configuration and operation of the storage battery system according to this embodiment, and illustrates a second state;

FIG. 2 is a schematic view schematically illustrating the configuration of the storage battery system according to this embodiment;

FIG. 3 is a block diagram illustrating a functional configuration of a control device configuring a part of the storage battery system according to this embodiment;

FIG. 4 is a flowchart illustrating a control flow relating to management of a deterioration level of a storage battery module in the storage battery system according to this embodiment;

FIG. 5 is a flowchart illustrating a control flow relating to management of supplied electric power in the storage battery system according to this embodiment;

FIG. 6A is a block diagram schematically illustrating a configuration and operation of a storage battery system according to a modification example of this embodiment, and illustrates a first state; and

FIG. 6B is a block diagram schematically illustrating a configuration and operation of the storage battery system according to the modification example of this embodiment, and illustrates a second state.

### DETAILED DESCRIPTION OF EMBODIMENTS

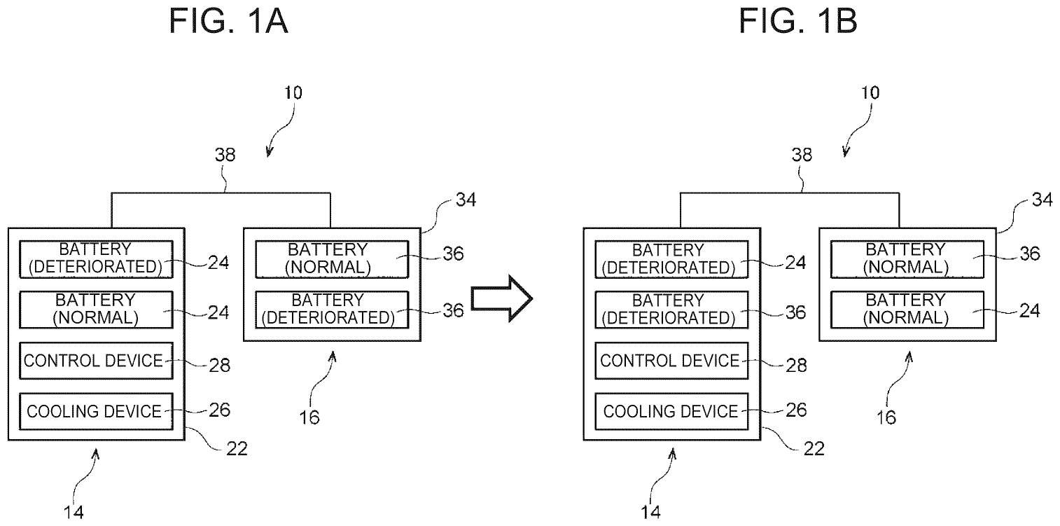

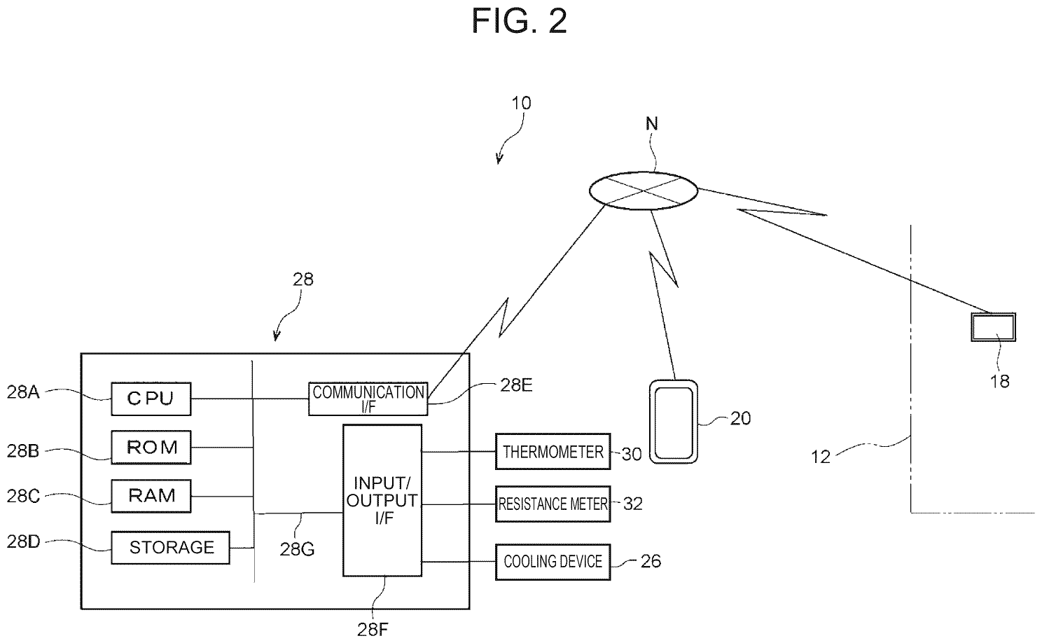

Hereinafter, with reference to FIG. 1A and FIG. 1B to FIG. 6A and FIG. 6B, an example of an embodiment of an electric power management system according to the disclosure is described. As illustrated in FIG. 1A, FIG. 1B, and FIG. 2, a “storage battery system 10” according to this embodiment includes a “main electricity storage device 14” disposed at a predetermined location within a site of a building 12 and an “electricity storage device 16 for expansion” that can be electrically connected to the main electricity storage device 14.

As illustrated in FIG. 1A, the main electricity storage device 14 includes a “case 22” serving as a first housing unit, “storage battery modules 24” serving as a plurality of first storage battery modules stored in the case 22, a “cooling device 26” serving as a cooling unit, and a “control device 28” serving as a control unit.

In detail, the case 22 includes a door (not shown) that can be opened and closed, and the storage battery module 24 can be taken in and out in a state in which the door is opened.

Meanwhile, the storage battery module 24 is configured of a plurality of lithium ion battery cells (not shown), and a plurality of storage battery modules 24 is continuously disposed in a height direction of the case 22. The storage battery modules 24 are electrically connected to a connection portion (not shown) provided in the case 22, and electric power can be supplied via the connection portion to various loads connected to the main electricity storage device 14.

Further, the storage battery module 24 can also be used as an on-vehicle battery by being mounted on a vehicle, and can supply electric power to various loads provided in the vehicle.

The cooling device 26 employs a water-cooled system, and can cool the storage battery modules 24. Specifically, the cooling device 26 includes a pipe (not shown) that is routed along disposing portions of the storage battery modules 24 in the case 22 and allows a refrigerant (water) to flow therethrough, a pump (not shown) that pumps the refrigerant, and a cooler (not shown) that cools the refrigerant. It is to be noted that the cooling device 26 is operated based on the control of the control device 28 as described later.

The control device 28 includes a central processing unit (CPU) 28A, a read only memory (ROM) 28B, a random access memory (RAM) 28C, a storage 28D, a communication interface (I/F) 28E, and an input/output I/F 28F. In addition, the CPU 28A, the ROM 28B, the RAM 28C, the storage 28D, the communication I/F 28E, and the input/output I/F 28F are connected to each other via a bus 28G to allow communication therebetween.

The CPU 28A is a central processing unit, and controls various devices through execution of various programs and performs control relating to the main electricity storage device 14 and the electricity storage device 16 for expansion. Specifically, the CPU 28A can read out a program from the ROM 28B and execute the program with use of the RAM 28C as a work area. In addition, with an execution program stored in the ROM 28B being read out and executed by the CPU 28A, the control device 28 can exert various functions as described later.

The storage 28D includes a hard disk drive (HDD) or a solid state drive (SSD), and stores various types of data and various programs including an operating system. Further, the storage 28D stores measurement results obtained by various measurement devices as described later.

The communication I/F 28E is an interface used for connection between the control device 28 and a network N, and can communicate with a monitor 18 installed in the building 12 and a mobile terminal 20 or the like used by a resident of the building 12. The interface uses a communication standard such as, for example, Ethernet (registered trademark), FDDI, or Wi-Fi (registered trademark). Further, the communication I/F 28E may include a wireless device.

The input/output I/F 28F is an interface for allowing the control device 28 to communicate with the cooling device 26, a thermometer 30 installed in the case 22, and a resistance meter 32 provided in the storage battery module 24 or the like.

Meanwhile, the electricity storage device 16 for expansion includes a “case 34” serving as a second housing unit, and “storage battery modules 36” serving as a plurality of second storage battery modules stored in the case 34.

In detail, the case 34 is configured similarly to the case 22, and allows the storage battery module 36 to be taken in or out. Further, the storage battery module 36 is referred to as the storage battery module 36 for the sake of convenience, but has the same configuration as the storage battery module 24. The storage battery module 24 and the storage battery module 36 are interchangeable. It is to be noted that the storage battery module 36 also includes the resistance meter 32 similarly to the storage battery module 24.

Moreover, the electricity storage device 16 for expansion can be electrically connected to the main electricity storage device 14 via a wire harness 38. In a state in which the main electricity storage device 14 and the electricity storage device 16 for expansion are connected to each other by the wire harness 38, the storage battery modules 24 and the storage battery modules 36 are brought to a state of being connected in parallel to each other.

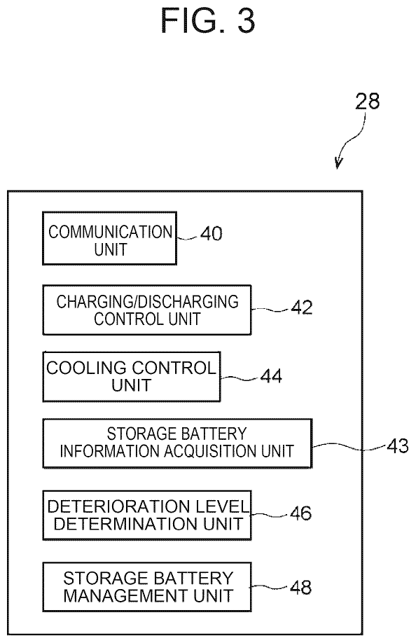

Next, a functional configuration of the control device 28 is described with reference to FIG. 3. With the CPU 28A reading out the execution program stored in the ROM 28B and executing the execution program, the control device 28 functions as an aggregation of a communication unit 40, a charging/discharging control unit 42, a cooling control unit 44, a storage battery information acquisition unit 43, a deterioration level determination unit 46, and a storage battery management unit 48.

The communication unit 40 can communicate with various devices via the network N, and, as illustrated in FIG. 2, can transmit and receive various pieces of information to and from the monitor 18 and the mobile terminal 20.

When the charging/discharging control unit 42 receives an electric power supply signal as input from a switch provided in the control device 28 or a predetermined terminal, the charging/discharging control unit 42 supplies the electric power stored in the storage battery modules 24 or the storage battery modules 36 to a load connected to the main electricity storage device 14.

Further, when the charging/discharging control unit 42 receives a charging start signal as input from the switch or the terminal, the charging/discharging control unit 42 charges the storage battery modules 24 or the storage battery modules 36 with electric power supplied from an external power supply connected to the main electricity storage device 14.

The storage battery information acquisition unit 43 can store information on a temperature in the case 22 acquired from the thermometer 30 and information on an internal resistance value of each of the storage battery modules 24 and the storage battery modules 36 acquired from the resistance meter 32, and can transmit those pieces of information to the cooling control unit 44, the deterioration level determination unit 46, and the storage battery management unit 48.

The cooling control unit 44 can control the cooling device 26 based on the information on the temperature in the case 22. Specifically, the cooling control unit 44 operates the cooling device 26 when the temperature in the case 22 is equal to or larger than a threshold value, and stops the cooling device 26 when the temperature in the case 22 is lower than the threshold value.

The deterioration level determination unit 46 can determine a deterioration level of each of the storage battery modules 24 and the storage battery modules 36 based on the information acquired from the storage battery information acquisition unit 43. Specifically, the deterioration level determination unit 46 compares, in each of the storage battery modules 24 and the storage battery modules 36, an internal resistance value at the time of start of use and a current internal resistance value to determine that the storage battery module 24 or the storage battery module 36 is deteriorated when a rate of increase of the internal resistance value becomes equal to or larger than a threshold value. That is, in this embodiment, the rate of increase of the internal resistance value with reference to the internal resistance value of an initial state of each of the storage battery modules 24 and the storage battery modules 36 is evaluated as the deterioration level of each of the storage battery modules 24 and the storage battery modules 36.

In addition, the deterioration level determination unit 46 notifies the monitor 18 and the mobile terminal 20 of management information of the deteriorated storage battery module 24 or storage battery module 36, for example, a serial number or the like of the deteriorated storage battery module 24 or storage battery module 36.

Further, the deterioration level determination unit 46 sets, based on the deterioration level of each of the storage battery modules 24 and the storage battery modules 36, optimum storage positions with respect to the case 22 and the case 34 of the storage battery module 24 and the storage battery module 36, and notifies the monitor 18 and the mobile terminal 20 of the storage positions of the storage battery module 24 and the storage battery module 36 based on the storage positions as management information.

The storage battery management unit 48 decides which electric power of the main electricity storage device 14 or the electricity storage device 16 for expansion is used in priority based on the information on the temperature in the case 22.

Specifically, the storage battery management unit 48 uses the electric power of the main electricity storage device 14 in priority when the temperature in the case 22 is equal to or larger than a threshold value, and uses the electric power of the electricity storage device 16 for expansion in priority when the temperature in the case 22 is lower than the threshold value.

### Actions and Effects of this Embodiment

Next, actions and effects of this embodiment are described.

As illustrated in FIG. 1A, the main electricity storage device 14 is provided, and the main electricity storage device 14 includes the case 22, and the plurality of storage battery modules 24 and the control device 28 stored in the case 22. In addition, the control device 28 can control the charging and discharging of the storage battery modules 24, and, in this embodiment, can charge the storage battery modules 24 by an external power supply or supply electric power from the storage battery modules 24 to a load.

Further, the case 22 stores the cooling device 26 that can cool the inside of the case 22, and the cooling device 26 can cool the storage battery modules 24 to prevent the storage battery modules 24 from being deteriorated.

Incidentally, when the supply of electric power to the load is insufficient only by the main electricity storage device 14, a storage battery module for expansion is required to be prepared. At this time, when a configuration in which the storage battery module for expansion is disposed in the case 22 is adopted, work of changing a part of the case 22 is required, and it is considered that installation of the storage battery module for expansion becomes complicated.

Here, in this embodiment, the electricity storage device 16 for expansion is provided, and the electricity storage device 16 for expansion includes the case 34 and the plurality of storage battery modules 36 stored in the case 34. In addition, the storage battery modules 36 can be electrically connected to the storage battery modules 24, and can be charged and discharged under control of the control device 28.

Accordingly, in this embodiment, when the supply of electric power to the load is insufficient only by the main electricity storage device 14, electric power can be supplied from the electricity storage device 16 for expansion to the main electricity storage device 14. That is, in this embodiment, the storage battery module can be added to the main electricity storage device 14 without disposing a storage battery module for expansion in the case 22.

Incidentally, the storage battery module 24 and the storage battery module 36 are deteriorated in accordance with the number of times of charging and discharging or the like, but the degree of the deterioration varies depending on each of the storage battery module 24 and the storage battery module 36. Further, the deterioration of the storage battery module 24 and the storage battery module 36 can be more delayed as the storage battery module 24 and the storage battery module 36 are used while being cooled, and hence using a storage battery module 24 or a storage battery module 36 having a large degree of deterioration while cooling the storage battery module 24 or the storage battery module 36 allows a life of the entire storage battery system 10 to be ensured.

Here, in this embodiment, the control device 28 can determine the deterioration level of each of the storage battery modules 24 and the storage battery modules 36. In addition, the control device 28 can give a notification of at least one of exchange between a predetermined storage battery module 24 and a predetermined storage battery module 36 and change of storage positions of the predetermined storage battery module 24 and the predetermined storage battery module 36, in accordance with the deterioration level of each of the storage battery modules 24 and the storage battery modules 36.

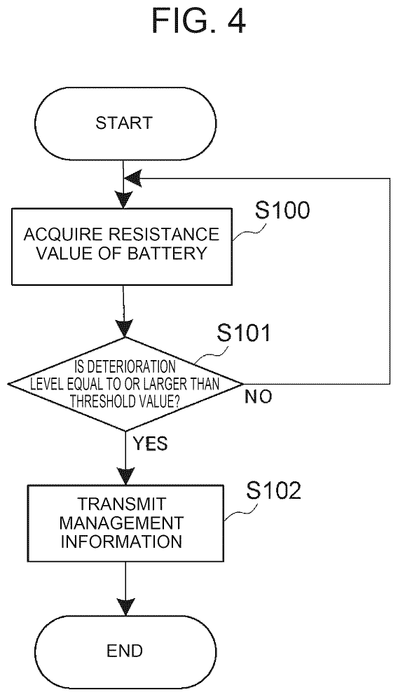

Hereinafter, with reference mainly to the flowchart of FIG. 4, a control flow relating to processing performed by the control device 28 at the time of management of the deterioration level of the storage battery module is described. The control flow is started when the CPU 28A of the control device 28 receives a predetermined control signal at each predetermined time.

When this control flow is started, in Step S100, the CPU 28A functions as the storage battery information acquisition unit 43 to acquire the information on the internal resistance value of each of the storage battery modules 24 and the storage battery modules 36, and proceeds to Step S101.

In Step S101, the CPU 28A functions as the deterioration level determination unit 46 to evaluate the deterioration level of each of the storage battery modules 24 and the storage battery modules 36 based on the information acquired from the storage battery information acquisition unit 43. Then, when it is determined that there is a storage battery module 24 or a storage battery module 36 having a deterioration level that is equal to or larger than a threshold value (Step S101: YES), the process proceeds to Step S102. Meanwhile, when it is determined that there is no storage battery module 24 or storage battery module 36 having a deterioration level that is equal to or larger than the threshold value (Step S101: NO), the process returns to Step S100.

In Step S102, the CPU 28A functions as the deterioration level determination unit 46 to notify the monitor 18 and the mobile terminal 20 of the management information of the storage battery module 24 and the storage battery module 36, and ends the control flow. Specifically, the CPU 28A transmits, to the monitor 18 and the mobile terminal 20, information such as a serial number for identifying the deteriorated storage battery module 24 or storage battery module 36 and information relating to optimums storage positions with respect to the case 22 and the case 34 of the storage battery module 24 and the storage battery module 36 based on the deterioration levels of the storage battery module 24 and the storage battery module 36.

Accordingly, the control device 28 can give a notification of, for example, exchange between a storage battery module 36 having a relatively large deterioration level stored in the case 34 and a storage battery module 24 having a relatively small deterioration level stored in the case 22.

As a result, an operator or the like who has received the notification can exchange the storage battery module 36 having a relatively large deterioration level and the storage battery module 24 having a relatively small deterioration level as illustrated in FIG. 1B. Thus, the storage battery module 36 is brought to a coolable state, and thus the deterioration of the storage battery module 36 can be reduced.

Further, the control device 28 can give a notification of, for example, the change of the position of the storage battery module 24 having a relatively large deterioration level stored in the case 22.

As a result, the operator or the like who has received the notification can dispose, inside of the case 22, a storage battery module 24 having a relatively large deterioration level to a position that is easily cooled by the cooling device 26, and dispose a storage battery module 24 having a relatively small deterioration level to a position that is difficult to be cooled by the cooling device 26. Thus, the deterioration levels of the storage battery modules 24 in the case 22 can be averaged.

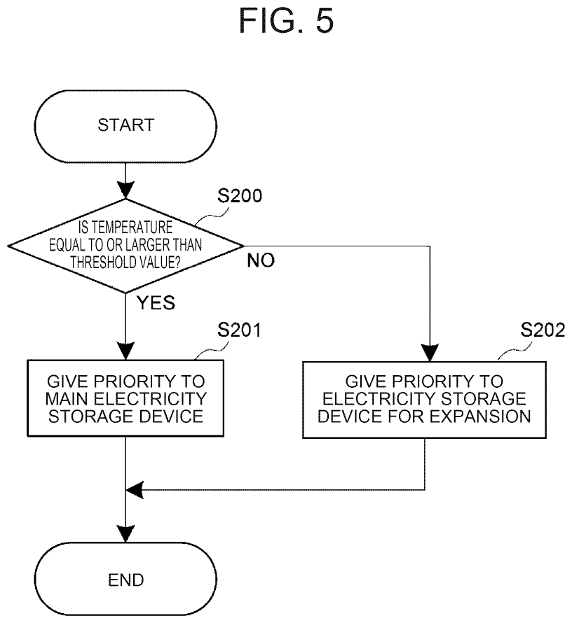

Further, in this embodiment, the control device 28 can set whether to use any one of the main electricity storage device 14 and the electricity storage device 16 for expansion for the supply of electric power to the load. Hereinafter, with reference mainly to the flowchart of FIG. 5, a control flow according to processing performed by the control device 28 at the time of management of supplied electric power of the storage battery module is described. The control flow is started when the CPU 28A of the control device 28 receives a predetermined control signal at each predetermined time.

When the control flow is started, in Step S200, the CPU 28A functions as the storage battery management unit 48 to determine whether or not the temperature in the case 22 is equal to or larger than a threshold value. Then, when it is determined that the temperature in the case 22 is equal to or larger than the threshold value (Step S200: YES), the process proceeds to Step S201. Meanwhile, when it is determined that the temperature in the case 22 is lower than the threshold value (Step S200: NO), the process proceeds to Step S202.

In Step S201, the CPU 28A functions as the storage battery management unit 48 to set a circuit such that the electric power is supplied from the storage battery modules 24 of the main electricity storage device 14 to the load, and ends the control flow.

In Step S202, the CPU 28A functions as the storage battery management unit 48 to set the circuit such that the electric power is supplied from the storage battery modules 36 of the electricity storage device 16 for expansion to the load, and ends the control flow.

Further, in this embodiment, the storage battery modules 24 and the storage battery modules 36 can be mounted on a vehicle, and can supply electric power to the vehicle.

Accordingly, for example, at the time of replacement or the like of the storage battery module 24 or the storage battery module 36 mounted on the vehicle, when the deterioration levels of the storage battery module 24 and the storage battery module 36 are smaller than the storage battery module 24 stored in the case 22 or the storage battery module 36 stored in the case 34, the storage battery module 24 or the storage battery module 36 that has been mounted on the vehicle can be reused as a part of the main electricity storage device 14 or a part of the electricity storage device 16 for expansion.

Further, in this embodiment, the main electricity storage device 14 and the electricity storage device 16 for expansion are installed at predetermined locations, and the main electricity storage device 14 and the electricity storage device 16 for expansion can supply electric power to a load in the building 12 or the like.

As described above, in this embodiment, the influence caused by the deterioration of the battery module can be reduced while the work of adding the battery module is prevented from becoming complicated.

### Modification Example of this Embodiment

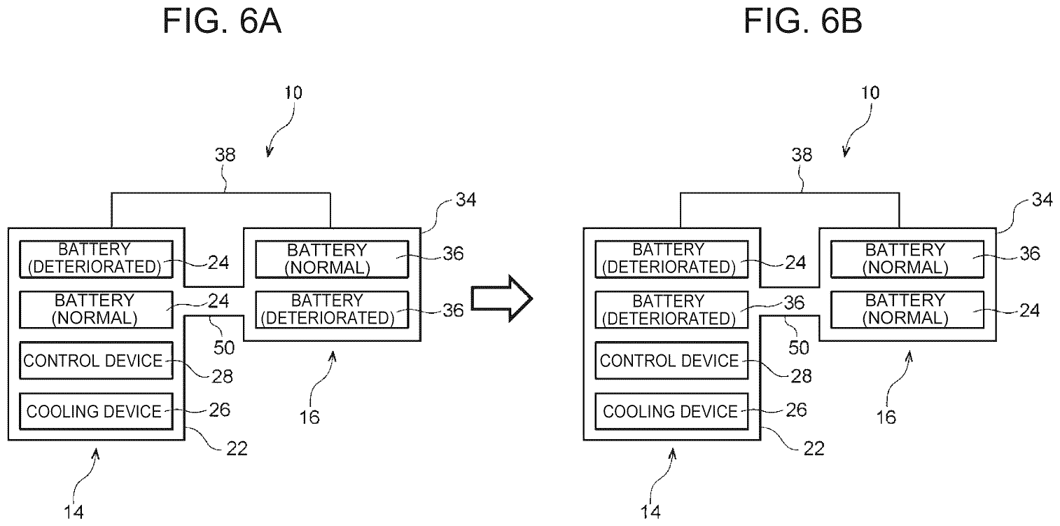

Hereinafter, with reference to FIG. 6A and FIG. 6B, a modification example of this embodiment is described.

In this modification example, as illustrated in FIG. 6A, the case 22 of the main electricity storage device 14 and the case 34 of the electricity storage device 16 for expansion are communicated with each other through a communicating portion 50, and the cooling device 26 employs an air-cooled system including an air blower fan or the like.

With such a configuration, the storage battery module 24 in the case 22 can be cooled by cold air generated by the cooling device 26 so that the deterioration of the storage battery module 24 can be reduced.

Further, in this embodiment, the case 22 and the case 34 are communicated with each other. Thus, the storage battery module 36 in the case 34 can be cooled by the cold air generated by the cooling device 26 so that the deterioration of the storage battery module 36 can be reduced. Further, as illustrated in FIG. 6B, in this modification as well, a storage battery module 36 having a relatively large deterioration level and a storage battery module 24 having a relatively small deterioration level can be exchanged. Thus, the storage battery module 36 can be brought to a more coolable state, and thus the deterioration of the storage battery module 36 can be reduced.

What is claimed is:

1. A storage battery system comprising:
a main electricity storage device including
a first housing unit,
a plurality of first storage battery modules stored in the first housing unit,
a cooling unit that is stored in the first housing unit and is configured to cool inside of the first housing unit, and
a control unit that is stored in the first housing unit and is configured to control charging and discharging of the first storage battery modules; and
an electricity storage device for expansion including
a second housing unit, and
a plurality of second storage battery modules stored in the second housing unit, the second storage battery modules being electrically connectable to the first storage battery modules and exchangeable with the first storage battery modules, the second storage battery modules being charged and discharged under control of the control unit,
wherein the control unit is configured to determine a deterioration level of each of the first storage battery modules and the second storage battery modules, and to give a notification of at least one of exchange between a predetermined one of the first storage battery modules and a predetermined one of the second storage battery modules and change of storage positions of the predetermined one of the first storage battery modules and the predetermined one of the second storage battery modules, in accordance with the deterioration level.

2. The storage battery system according to claim 1, wherein the first storage battery modules and the second storage battery modules are mountable on a vehicle and are configured to supply electric power to the vehicle.

3. The storage battery system according to claim 1, wherein the main electricity storage device and the electricity storage device for expansion are installed at predetermined locations.

4. The storage battery system according to claim 1, wherein:
the cooling unit employs an air-cooled system; and
the first housing unit and the second housing unit are communicated with each other.
